(19) United States
(12) Patent Application Publication
(10) Pub. No.: US 2026/0271030 A1
(43) Pub. Date: Sep. 10, 2026

(54) SECOND STARTING SYMBOL LOCATION IN SIDELINK UNLICENSED

(71) Applicant: QUALCOMM INCORPORATED, San Diego, CA (US)

(72) Inventors: Luanxia YANG, Beijing (CN); Chih-Hao LIU, San Diego, CA (US); Changlong XU, Beijing (CN); Shaozhen GUO, Beijing (CN); Siyi CHEN, Beijing (CN); Xiaoxia ZHANG, San Diego, CA (US); Jing SUN, San Diego, CA (US)

(21) Appl. No.: 19/168,244

(22) PCT Filed: Jun. 2, 2023
(86) PCT No.: PCT/CN2023/097959

§ 371 Date: Sep. 23, 2025

(51) Int. Cl. H04W 72/25; H04W 74/0808

(52) U.S. Cl. CPC H04W 72/25; H04W 74/0808

(57) ABSTRACT

Various aspects of the present disclosure generally relate to wireless communication. In some aspects, a user equipment (UE) may transmit information that indicates a transmission (Tx) capability and a reception (Rx) capability respectively related to transmitting and receiving a sidelink communication over an unlicensed channel. The UE may receive a configuration that indicates, within a sidelink slot, a first candidate starting symbol and a second candidate starting symbol for a sidelink transmission, wherein the second candidate starting symbol is based on one or more of the Tx capability or the Rx capability. Numerous other aspects are described.

### FIELD OF THE DISCLOSURE

Aspects of the present disclosure generally relate to wireless communication and to techniques and apparatuses associated with a second starting symbol location in sidelink unlicensed.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include one or more memories and one or more processors coupled to the one or more memories. The one or more processors may be configured to transmit information that indicates a transmission (Tx) capability and a reception (Rx) capability respectively related to transmitting and receiving a sidelink communication over an unlicensed channel. The one or more processors may be configured to receive a configuration that indicates, within a sidelink slot, a first candidate starting symbol and a second candidate starting symbol for a sidelink transmission, wherein the second candidate starting symbol is based on one or more of the Tx capability or the Rx capability.

Some aspects described herein relate to a method of wireless communication performed by a UE. The method may include transmitting information that indicates a Tx capability and an Rx capability respectively related to transmitting and receiving a sidelink communication over an unlicensed channel. The method may include receiving a configuration that indicates, within a sidelink slot, a first candidate starting symbol and a second candidate starting symbol for a sidelink transmission, wherein the second candidate starting symbol is based on one or more of the Tx capability or the Rx capability.

Some aspects described herein relate to a non-transitory computer-readable medium that stores a set of instructions for wireless communication by a UE. The set of instructions, when executed by one or more processors of the UE, may cause the UE to transmit information that indicates a Tx capability and an Rx capability respectively related to transmitting and receiving a sidelink communication over an unlicensed channel. The set of instructions, when executed by one or more processors of the UE, may cause the UE to receive a configuration that indicates, within a sidelink slot, a first candidate starting symbol and a second candidate starting symbol for a sidelink transmission, wherein the second candidate starting symbol is based on one or more of the Tx capability or the Rx capability.

Some aspects described herein relate to an apparatus for wireless communication. The apparatus may include means for transmitting information that indicates a Tx capability and an Rx capability respectively related to transmitting and receiving a sidelink communication over an unlicensed channel. The apparatus may include means for receiving a configuration that indicates, within a sidelink slot, a first candidate starting symbol and a second candidate starting symbol for a sidelink transmission, wherein the second candidate starting symbol is based on one or more of the Tx capability or the Rx capability.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of sidelink communications, in accordance with the present disclosure.

FIG. 4 is a diagram illustrating examples of sidelink communications in different coverage scenarios, in accordance with the present disclosure.

FIG. 5 is a diagram illustrating examples of a sidelink slot structure with two candidate starting symbols, in accordance with the present disclosure.

FIG. 6 is a diagram illustrating examples associated with a second starting symbol location in sidelink unlicensed, in accordance with the present disclosure.

FIG. 7 is a diagram illustrating an example process associated with a second starting symbol location in sidelink unlicensed, in accordance with the present disclosure.

FIG. 8 is a diagram of an example apparatus for wireless communication, in accordance with the present disclosure.

### DETAILED DESCRIPTION

In some cases, two or more user equipments (UEs) may communicate on a sidelink over unlicensed spectrum, where access to an unlicensed channel is subject to a channel access mechanism. For example, in a shared or unlicensed frequency band, a transmitting device (e.g., a transmitting UE) may contend against other devices for channel access before transmitting on a shared or unlicensed channel (e.g., to a receiving UE) to reduce and/or prevent collisions on the shared or unlicensed channel. To contend for channel access, the transmitting device may perform a channel access procedure, such as a listen-before-talk (or listen-before-transmit) (LBT) procedure or another type of channel access procedure, for shared or unlicensed frequency band channel access. The channel access procedure may be performed to determine whether the physical channel (e.g., the radio resources of the channel) are free to be used or are busy (e.g., in use by another wireless communication device such as a UE, an Internet of Things (IoT) device, or a wireless local area network (WLAN) device, among other examples). The channel access procedure may include sensing or measuring the physical channel (e.g., performing a reference signal received power (RSRP) measurement, detecting an energy level, or performing another type of measurement) during a channel access gap (which may also be referred to as a contention window) and determining whether the shared or unlicensed channel is free or busy based on the signals sensed or measured on the physical channel (e.g., based at least in part on whether the measurement satisfies a threshold). If the transmitting device determines that the channel access procedure was successful, the transmitting device may perform one or more transmissions on the shared or unlicensed channel during a transmission opportunity, which may extend for a channel occupancy time (COT).

In general, when a transmitting UE acquires or otherwise obtains a COT that allows the transmitting UE to transmit one or more sidelink communications over an unlicensed channel (e.g., after performing a successful LBT procedure), the transmitting UE may attempt to occupy the medium as soon as possible after the successful LBT procedure (e.g., to prevent an intervening WLAN device from accessing the medium). Accordingly, in some cases, a sidelink slot structure may be configured to include more than one candidate starting symbol to allow the transmitting UE to occupy the medium as soon as possible. For example, in cases where the LBT procedure is deemed to be successful after the first starting symbol in a current slot but before the second starting symbol in the current slot, the transmitting UE may start to transmit in the second starting symbol of the current slot rather than having to wait until a next slot (e.g., as would be the case when the sidelink slot structure includes only one starting symbol). However, configuring the specific location for the second starting symbol within a sidelink slot poses various challenges. For example, because different transmitting UEs may have different capabilities (e.g., needing different amounts of time to generate a waveform), one potential approach may be to configure a common second starting symbol for all UEs such that all transmitting UEs will have sufficient time to generate the waveform. However, this approach may lead to wasted resources and/or delays in accessing the medium (e.g., potentially allowing other contending devices to access the medium) for UEs that need relatively less time to generate the waveform. Accordingly, another potential approach may be to configure the second starting symbol to occur earlier in the slot. However, this approach also suffers from drawbacks, including that some transmitting UEs may fail to access the medium by the second starting symbol.

Some aspects described herein relate to techniques to configure, within a sidelink slot, a second candidate starting symbol for performing a sidelink transmission (e.g., a physical sidelink control channel (PSCCH) transmission and/or a physical sidelink shared channel (PSSCH) transmission) based on a transmission (Tx) capability and a reception (Rx) capability associated with one or more UEs. For example, in some aspects, a sidelink slot may support multiple possible locations for the second candidate starting symbol, and one of the multiple possible locations may be configured as the second candidate starting symbol for performing the sidelink transmission based on the Tx capability of a transmitting UE performing the sidelink transmission and/or the Rx capability of a receiving UE intended to receive the sidelink transmission. For example, in some aspects, the Tx capability may generally relate to a capability to perform a sidelink transmission over an unlicensed channel or other shared spectrum, which may include parameters such as a required time duration for generating a waveform corresponding to the sidelink transmission, one or more supported locations for the second starting symbol, and/or a minimum gap (e.g., a minimum number of symbols) that the transmitting UE needs to have between the first candidate starting symbol and the second candidate starting symbol. Furthermore, in some aspects, the Rx capability may generally relate to a capability to receive a sidelink transmission over an unlicensed channel or other shared spectrum, which may include parameters such as a maximum number of symbols for which the receiving UE supports blind detection and/or one or more supported locations for a PSCCH. Accordingly, a scheduling node (e.g., a network node or a UE) may configure a location for the second candidate starting symbol within a slot based on the Tx capability of the transmitting UE and/or the Rx capability of the receiving UE, which may ensure that the second candidate starting symbol is optimally situated at a location within a sidelink slot to allow the transmitting UE to occupy the medium as soon as possible after performing a successful LBT procedure, provide sufficient time for the transmitting UE to generate the waveform corresponding to the sidelink transmission, and/or allow the receiving UE to detect the waveform corresponding to the sidelink transmission, among other examples.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

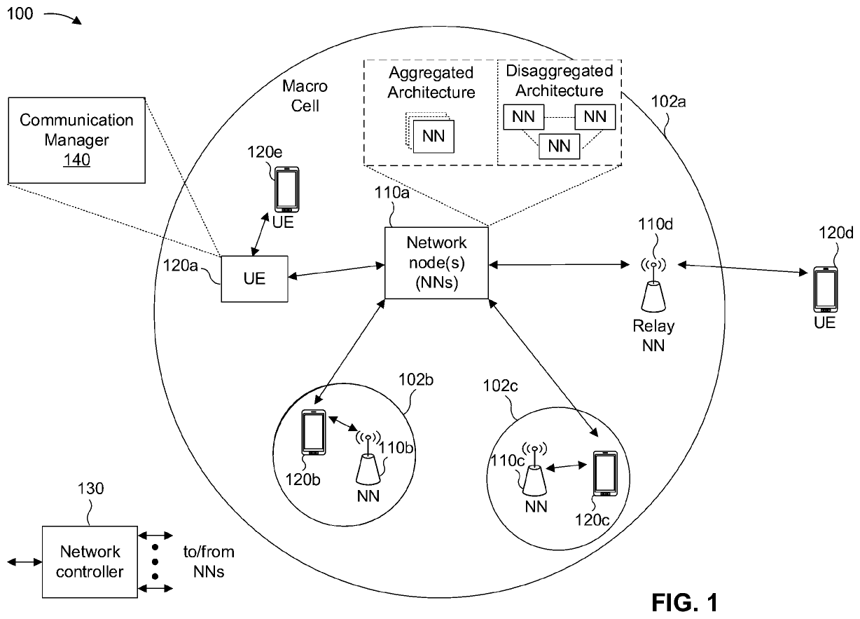

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 11Oa may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelhy (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered IoT devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit information that indicates a Tx capability and an Rx capability respectively related to transmitting and receiving a sidelink communication over an unlicensed channel; and receive a configuration that indicates, within a sidelink slot, a first candidate starting symbol and a second candidate starting symbol for a sidelink transmission, wherein the second candidate starting symbol is based on one or more of the Tx capability or the Rx capability. Additionally, or alternatively, the communication manager 140 may perform one or more other operations described herein.

As indicated above, FIG. 1 is provided as an example. Other examples may differ from what is described with regard to FIG. 1.

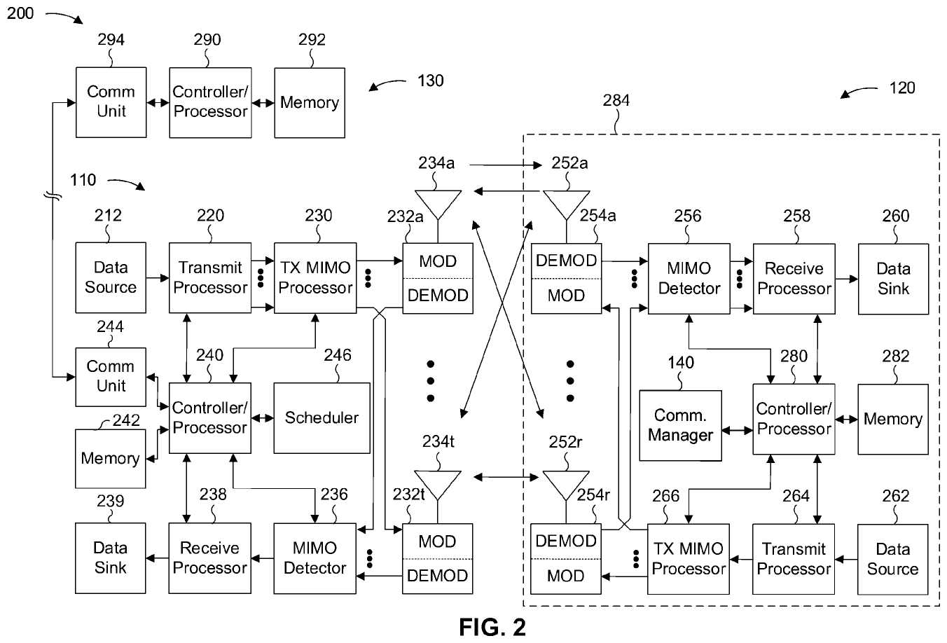

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine an RSRP parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

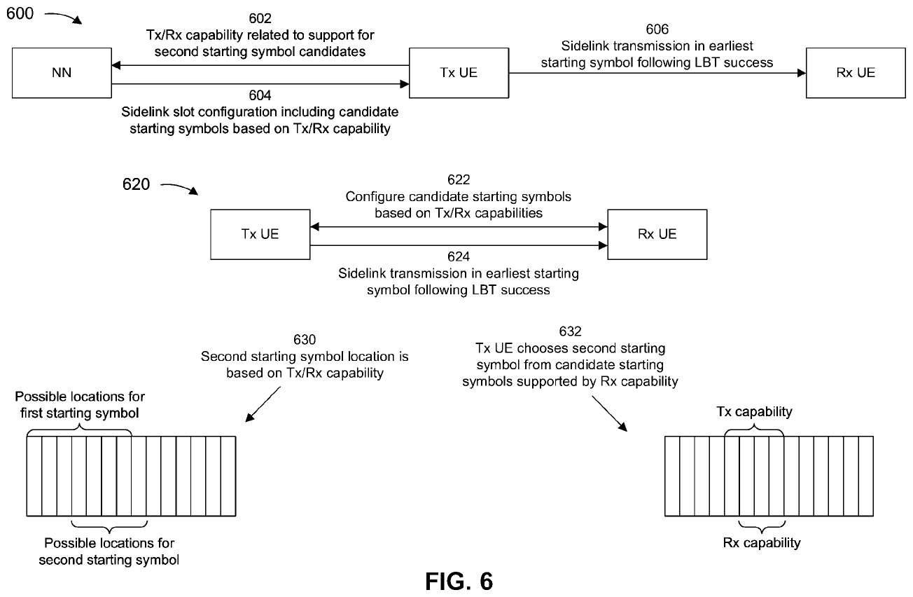

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-8).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-8).

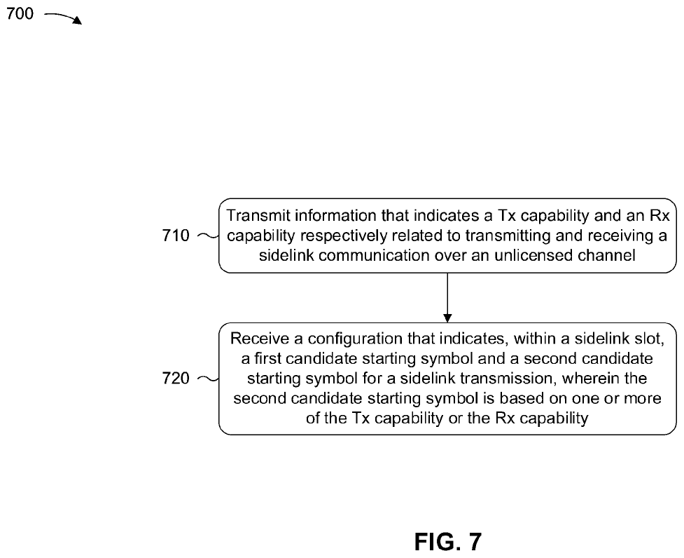

The controller/processor 240 of the network node 110, the controller/processor 280 of the UE 120, and/or any other component(s) of FIG. 2 may perform one or more techniques associated with a second starting symbol location in sidelink unlicensed (e.g., sidelink communication in unlicensed spectrum), as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7 and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7 and/or other processes as described herein. In some examples, executing instructions may include running the instructions, converting the instructions, compiling the instructions, and/or interpreting the instructions, among other examples.

In some aspects, the UE 120 includes means for transmitting information that indicates a Tx capability and an Rx capability respectively related to transmitting and receiving a sidelink communication over an unlicensed channel; and/or means for receiving a configuration that indicates, within a sidelink slot, a first candidate starting symbol and a second candidate starting symbol for a sidelink transmission, wherein the second candidate starting symbol is based on one or more of the Tx capability or the Rx capability. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

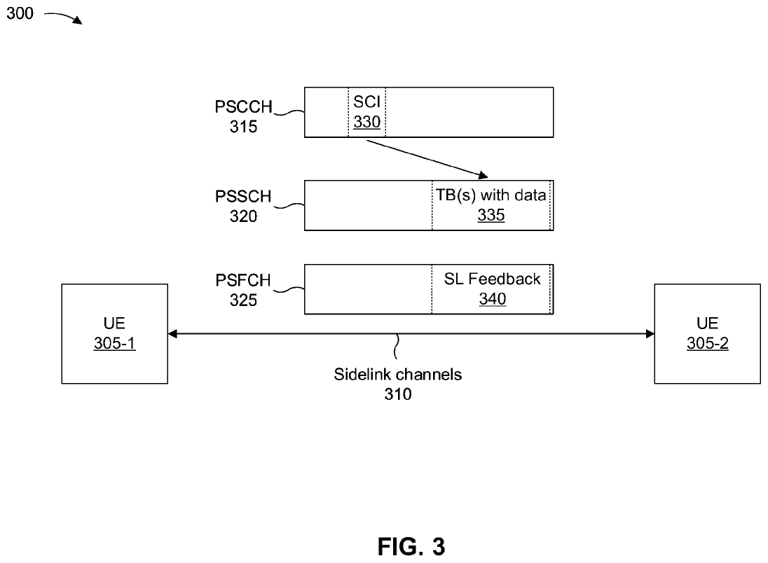

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a PSCCH 315, a PSSCH 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a network node 110 via an access link or an access channel. The PSSCH 320 may be used to communicate data, similar to a physical downlink shared channel (PDSCH) and/or a physical uplink shared channel (PUSCH) used for cellular communications with a network node 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QoS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 320, such as a HARQ process ID, a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in subchannels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a first sidelink transmission mode (e.g., mode 1, which may be referred to herein as a centralized scheduling mode or a network-controlled scheduling mode) in which resource selection and/or scheduling is performed by a base station 110. For example, in the centralized or network-controlled scheduling mode, the UE 305 may receive a grant (e.g., in downlink control information (DCI) or in a radio resource control (RRC) message, such as for configured grants) from the network node 110 for sidelink channel access and/or scheduling. In some aspects, a UE 305 may operate using a second sidelink transmission mode (e.g., mode 2, which may be referred to herein as a distributed scheduling mode or an autonomous scheduling mode) in which resource selection and/or scheduling is performed by the UE 305 (e.g., rather than a network node 110). In some aspects, the UE 305 may perform resource selection and/or scheduling in the distributed or autonomous scheduling mode by sensing channel availability for transmissions. For example, the UE 305 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling in the distributed or autonomous scheduling mode using SCI 330 received in the PSCCH 315, which may indicate occupied resources and/or channel parameters. Additionally, or alternatively, the UE 305 may perform resource selection and/or scheduling by determining a channel busy rate (CBR) associated with various sidelink channels, which may be used for rate control (e.g., by indicating a maximum number of resource blocks that the UE 305 can use for a particular set of subframes).

In the distributed or autonomous scheduling mode, where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or an MCS to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As indicated above, FIG. 3 is provided as an example. Other examples may differ from what is described with regard to FIG. 3.

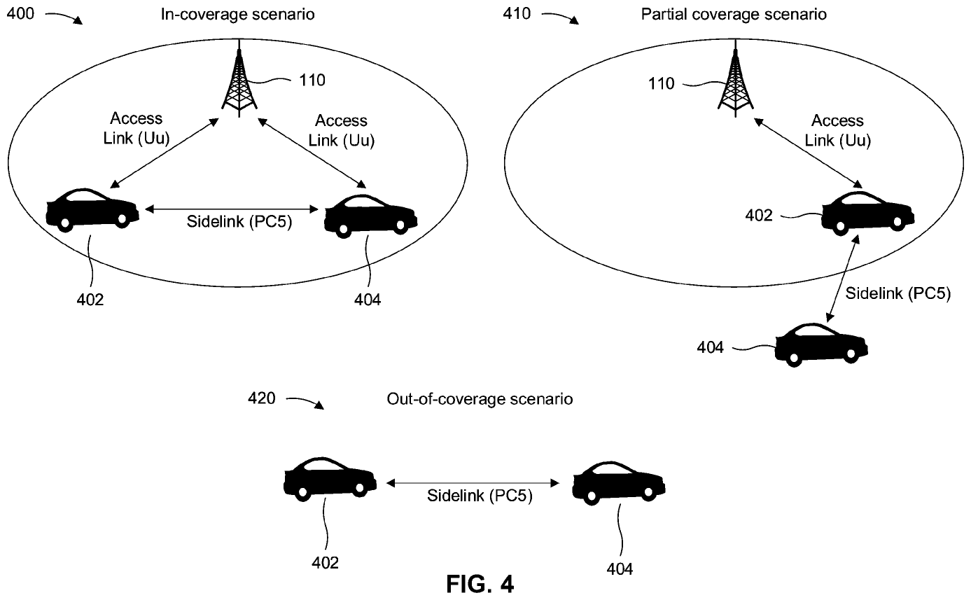

FIG. 4 is a diagram illustrating examples of sidelink communications in different coverage scenarios 400, 410, 420, in accordance with the present disclosure. For example, FIG. 4 illustrates an example of sidelink communications in an in-coverage scenario 400, an example of sidelink communications in a partial coverage scenario 410, and an example of sidelink communications in an out-of-coverage scenario 420.

As shown in FIG. 4, in the in-coverage scenario 400, a Tx/Rx UE 402 and an Rx/Tx UE 404 may communicate with one another via a sidelink (e.g., a PC5 interface), as described above in connection with FIG. 3, and a network node 110 may communicate with the Tx/Rx UE 402 via a first access link and with the Rx/Tx UE 404 via a second access link (e.g., respective Uu interfaces). As shown, in the in-coverage scenario 400, the Tx/Rx UE 402 and the Rx/Tx UE 404 are both within the coverage of the network node 110, whereby sidelink communication between the Tx/Rx UE 402 and the Rx/Tx UE 404 may be performed in a centralized or network-controlled scheduling mode (e.g., mode 1) in which the network node 110 schedules sidelink resources, or in a distributed or autonomous scheduling mode (e.g., mode 2) in which the UEs 402/404 autonomously select sidelink resources from a configured sidelink resource pool based on a channel sensing mechanism.

As further shown in FIG. 4, in the in-coverage scenario 410, a Tx/Rx UE 402 is within the coverage area of a network node 110, and an Rx/Tx UE 404 is outside the coverage area of the network node 110. In the in-coverage scenario 410, the Tx/Rx UE 402 and the Rx/Tx UE 404 may communicate with one another via a sidelink (e.g., a PC5 interface), and the network node 110 may communicate with the Tx/Rx UE 402 via an access link (e.g., a Uu interface). Accordingly, in the in-coverage scenario 410, the network node 110 may enable either the centralized scheduling mode or the distributed scheduling mode for the Tx/Rx UE 402 within the coverage area of the network node 110, and the Rx/Tx UE 404 that is out-of-coverage may use only the distributed scheduling mode. Furthermore, in the out-of-coverage scenario 420, the Tx/Rx UE 402 and the Rx/Tx UE 404 are outside the coverage area of any network node. Accordingly, in the out-of-coverage scenario 420, only the distributed scheduling mode can be used to enable sidelink communication between the Tx/Rx UE 402 and the Rx/Tx UE 404.

As described herein, when a UE is to perform a sidelink transmission, the sidelink transmission may be performed according to one or more sidelink procedures and/or using one or more transmission parameters that are configured to streamline a channel access scheme that sidelink UEs follow either in the centralized or network-controlled scheduling mode or in the distributed or autonomous scheduling mode. In general, all communication parameters (e.g., transmission parameters such as transmit power and/or DMRS pattern, and procedural parameters indicating whether certain sidelink features and/or procedures are enabled or disabled) are centrally selected or otherwise controlled by the network in the centralized scheduling mode (e.g., mode 1). For example, in the centralized scheduling mode, a network node is aware of congestion, traffic conditions, interference, load, and/or other factors that may impact performance of the network node and the UEs within the coverage area of the network node, and the network node configures the sidelink communication parameters accordingly to optimize overall sidelink and/or cellular performance and/or per-UE performance.

On the other hand, in the distributed scheduling mode, there are various sidelink communication parameters that are independently or autonomously selected by a Tx UE. For example, in the distributed scheduling mode, sidelink communication parameters may include globally configured parameters that have fixed values (e.g., a number of subchannels, a bandwidth of the subchannels, and/or a slot duration, among other examples) and locally configured parameters whose selection is left to the Tx UE. For example, the locally configured parameters may include an MCS, a DMRS pattern, a transmit power, a maximum number of retransmissions for a given TB, a groupcast option 1 NACK distance (e.g., a distance over which a receiving UE can send a NACK for a sidelink transmission), and/or a beta parameter (e.g., related to coding associated with a transmitted waveform), among other examples. In some cases, the Tx UE may select the locally configured parameters independently, possibly restricted over a set of allowed or permitted values, with the locally configured parameters having values that are selected by the UE in order to optimize performance of the UE with respect to one or more metrics that are typically application-dependent. For example, a Tx UE may select an MCS and a maximum number of HARQ retransmissions to maximize packet reliability, maximize throughput, and/or minimize latency, among other examples. Furthermore, the Tx UE may select the locally configured parameters according to a preconfigured scheme (e.g., using a default value that may be application-dependent, such as a default value for a basic safety message (BSM)) and/or using more sophisticated techniques based on on-the-fly (e.g., current or instantaneous) measurements such as a CBR or perceived congestion on a sidelink channel.

As indicated above, FIG. 4 is provided as an example. Other examples may differ from what is described with regard to FIG. 4.

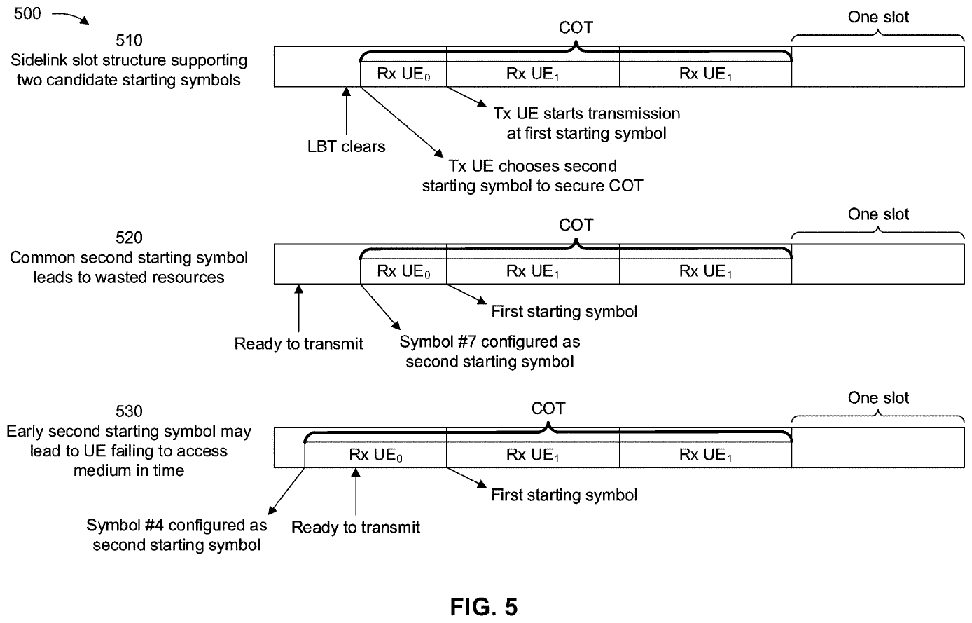

FIG. 5 is a diagram illustrating examples 500 of a sidelink slot structure with two candidate starting symbols, in accordance with the present disclosure.

In some cases, two or more UEs may communicate on a sidelink over unlicensed spectrum, where access to an unlicensed channel is subject to a channel access mechanism. For example, in a shared or unlicensed frequency band, a transmitting device (e.g., a transmitting UE) may contend against other devices for channel access before transmitting on a shared or unlicensed channel (e.g., to a receiving UE) to reduce and/or prevent collisions on the shared or unlicensed channel. To contend for channel access, the transmitting device may perform a channel access procedure, such as an LBT procedure or another type of channel access procedure, for shared or unlicensed frequency band channel access. The channel access procedure may be performed to determine whether the physical channel (e.g., the radio resources of the channel) are free to be used or are busy (e.g., in use by another wireless communication device such as a UE, an IoT device, or a WLAN (or Wi-Fi) device, among other examples). The channel access procedure may include sensing or measuring the physical channel (e.g., performing an RSRP measurement, detecting an energy level, or performing another type of measurement) during a channel access gap (which may also be referred to as a contention window) and determining whether the shared or unlicensed channel is free or busy based on the signals sensed or measured on the physical channel (e.g., based on whether the measurement satisfies a threshold). If the transmitting device determines that the channel access procedure was successful, the transmitting device may perform one or more transmissions on the shared or unlicensed channel during a transmission opportunity, which may extend for a COT.

In general, when a transmitting UE acquires or otherwise obtains a COT that allows the transmitting UE to transmit one or more sidelink communications over an unlicensed channel (e.g., after performing a successful LBT procedure), the transmitting UE may attempt to occupy the medium as soon as possible after the successful LBT procedure (e.g., to prevent an intervening WLAN device from accessing the medium). Accordingly, in some cases, a sidelink slot structure may be configured to include more than one candidate starting symbol to allow the transmitting UE to occupy the medium as soon as possible. For example, in cases where the LBT procedure is deemed to be successful after the first starting symbol in a current slot but before the second starting symbol in the current slot, the transmitting UE may start to transmit in the second starting symbol of the current slot rather than having to wait until a next slot (e.g., as would be the case when the sidelink slot structure includes only one starting symbol).

For example, referring to FIG. 5, reference number 510 illustrates an example sidelink slot structure that supports two candidate starting symbols, where a transmitting UE can start to perform a PSCCH transmission and/or a PSSCH transmission in either the first candidate starting symbol or the first candidate starting symbol within a slot (e.g., depending on whether the transmitting UE completes a successful LBT procedure). In general, within a sidelink slot, the first candidate starting symbol may correspond to any of the first seven symbols within the slot (e.g., symbols associated with index 0 through index 6), which may be configured per bandwidth part. Alternatively, in cases where the first candidate starting symbol is not specifically configured, a default location for the first candidate starting symbol may be the first symbol within the slot (e.g., the symbol associated with index 0). Furthermore, the second candidate starting symbol may correspond to any of the fourth through eighth symbols within the slot (e.g., symbols associated with index 3 through index 7), which also may be configured per bandwidth part. For example, the second candidate starting symbol may be configured such that at least six symbols are available to be used for a PSCCH and/or PSSCH transmission that starts in the second candidate starting symbol, whereby the eighth symbol within the slot is the latest possible location for the second candidate starting symbol. Furthermore, within a slot, the second candidate starting symbol is later than the first candidate starting symbol, and a PSCCH and/or PSSCH transmission has the same ending symbol within a slot regardless of whether the PSCCH and/or PSSCH transmission starts in the first candidate starting symbol or the second candidate starting symbol. For example, as shown by reference number 510, the sidelink slot is associated with a configuration in which the first candidate starting symbol is the first symbol within the slot (e.g., a symbol associated with index 0) and the second candidate starting symbol is the eighth symbol within the slot (e.g., a symbol associated with index 7). In this case, the transmitting UE performs a successful LBT procedure that clears after the first candidate starting symbol, but before the second candidate starting symbol. Accordingly, the transmitting UE may select the second candidate starting symbol (associated with index 7), and start to transmit in the second candidate starting symbol to secure the COT following the successful LBT procedure. In the subsequent slot(s), while the COT is ongoing, the transmitting UE may start to perform PSCCH and/or PSSCH transmissions in the first candidate starting symbol.

However, configuring the specific location for the second starting symbol within a sidelink slot poses various challenges. For example, because different transmitting UEs may have different capabilities (e.g., needing different amounts of time to generate a waveform), one potential approach may be to configure a common second starting symbol for all UEs such that all transmitting UEs will have sufficient time to generate the waveform. However, this approach may lead to wasted resources and/or delays in accessing the medium (e.g., potentially allowing other contending devices to access the medium) for UEs that need relatively less time to generate the waveform. For example, in FIG. 5, reference number 520 depicts a scenario where the first candidate starting symbol is the first symbol within the slot and the second candidate starting symbol is the eighth symbol within the slot (e.g., symbols associated with indexes 0 and 7, respectively), and the transmitting UE is ready to transmit (e.g., following a successful LBT procedure) relatively early in the slot (e.g., within one or two symbols after the first candidate starting symbol). However, the transmitting UE has to wait until the eighth symbol in the slot before starting to transmit, which increases the time that the medium is unoccupied and increases a probability that another contending device (e.g., a WLAN device) could access the medium.

Accordingly, another potential approach may be to configure the second starting symbol to occur earlier in the slot. However, this approach also suffers from drawbacks, including that some transmitting UEs may fail to access the medium by the second starting symbol. For example, reference number 530 depicts a scenario where the first candidate starting symbol is the first symbol within the slot and the second candidate starting symbol is the fifth symbol within the slot (e.g., symbols associated with indexes 0 and 4, respectively). In this case, the transmitting UE may be unable to complete a successful LBT procedure and/or generate a waveform before the second candidate starting symbol, whereby the transmitting UE is ready to transmit after the second candidate starting symbol. In this case, the transmitting UE is unable to start transmitting within the current slot, and has to wait until the first candidate starting symbol in the subsequent slot before starting to transmit, which also increases the time that the medium is unoccupied and increases a probability that another contending device (e.g., a WLAN device) could access the medium in the intervening time period.

Some aspects described herein relate to techniques to configure, within a sidelink slot, a second candidate starting symbol for performing a sidelink transmission (e.g., a PSCCH transmission and/or a PSSCH transmission) based on a Tx capability and a Rx capability associated with one or more UEs. For example, in some aspects, a sidelink slot may support multiple possible locations for the second candidate starting symbol, and one of the multiple possible locations may be configured as the second candidate starting symbol for performing the sidelink transmission based on the Tx capability of a transmitting UE performing the sidelink transmission and/or the Rx capability of a receiving UE intended to receive the sidelink transmission. For example, in some aspects, the Tx capability may generally relate to a capability to perform a sidelink transmission over an unlicensed channel or other shared spectrum, which may include parameters such as a required time duration for generating a waveform corresponding to the sidelink transmission, one or more supported locations for the second starting symbol, and/or a minimum gap (e.g., a minimum number of symbols) that the transmitting UE needs to have between the first candidate starting symbol and the second candidate starting symbol. Furthermore, in some aspects, the Rx capability may generally relate to a capability to receive a sidelink transmission over an unlicensed channel or other shared spectrum, which may include parameters such as a maximum number of symbols for which the receiving UE supports blind detection and/or one or more supported locations for a PSCCH. Accordingly, a scheduling node (e.g., a network node or a UE) may configure a location for the second candidate starting symbol within a slot based on the Tx capability of the transmitting UE and/or the Rx capability of the receiving UE, which may ensure that the second candidate starting symbol is optimally situated at a location within a sidelink slot to allow the transmitting UE to occupy the medium as soon as possible after performing a successful LBT procedure, provide sufficient time for the transmitting UE to generate the waveform corresponding to the sidelink transmission, and/or allow the receiving UE to detect the waveform corresponding to the sidelink transmission, among other examples.

As indicated above, FIG. 5 is provided as an example. Other examples may differ from what is described with regard to FIG. 5.

FIG. 6 is a diagram illustrating examples 600, 620 associated with a second starting symbol location in sidelink unlicensed, in accordance with the present disclosure. As shown in FIG. 6, example 600 includes a Tx UE (e.g., UE 120, UE 305, UE 402, or UE 404) and an Rx UE (e.g., UE 120, UE 305, UE 402, or UE 404) that communicate with one another via a sidelink channel (e.g., over a PC5 interface) and with a network node (e.g., network node 110) via an access link (e.g., over a Uu interface). As further shown in FIG. 6, example 620 includes a Tx UE (e.g., UE 120, UE 305, UE 402, or UE 404) and an Rx UE (e.g., UE 120, UE 305, UE 402, or UE 404) that communicate with one another via a sidelink channel (e.g., over a PC5 interface).

In some aspects, as shown in example 600, the Tx UE and the Rx UE may communicate with each other over the sidelink channel and with the network node over the access link in accordance with mode 1 scheduling, where sidelink communication is configured and/or scheduled by the network node. Furthermore, in example 600, the sidelink channel that the Tx UE and the Rx UE use to communicate is an unlicensed channel subject to a channel access mechanism (e.g., LBT). Accordingly, as shown by reference number 602, the Tx UE may transmit, and the network node may receive, Tx/Rx capability information that indicates, respectively, a Tx capability and an Rx capability of the Tx UE related to transmitting and receiving a sidelink communication over the unlicensed channel. Furthermore, although not explicitly shown in FIG. 6, the Rx UE may similarly transmit Tx/Rx capability information that indicates the Tx capability and the Rx capability of the Rx UE (e.g., in an in-coverage scenario). For example, as described in further detail herein, the Tx UE and the Rx UE may transmit the Tx/Rx capability information in an RRC message or a medium access control (MAC) control element (MAC-CE), which may include one or more parameters relevant to the capability of the Tx UE and/or the Rx UE to transmit and/or receive a sidelink communication in a second candidate starting symbol within a sidelink slot. Furthermore, in some aspects, the Tx UE and the Rx UE may indicate their respective Tx/Rx capabilities to each other (e.g., even in an in-coverage or partial coverage scenario) through one or more PC5-RRC messages (e.g., to enable the Tx UE to select an appropriate starting second symbol based on the Rx capabilities of the Rx UE).

Accordingly, as shown by reference number 604, the network node may transmit information related to a sidelink slot configuration to the Tx UE and/or the Rx UE, where the sidelink slot configuration may include a first candidate starting symbol and a second candidate starting symbol. In some aspects, the first candidate starting symbol may correspond to any of the first seven symbols within a sidelink slot, which may be configured based on the bandwidth part that the Tx UE and the Rx UE use to communicate over the sidelink channel.

Alternatively, the first candidate starting symbol may not be explicitly configured, in which case the first candidate starting symbol may correspond to the first symbol in the sidelink slot (symbol 0). The second candidate starting symbol is generally configured to be later than the first candidate starting symbol, and may otherwise be located in any of the fourth through eighth symbols within the sidelink slot. Furthermore, in some aspects, the location of the second candidate starting symbol may be configured based on the Tx/Rx capability information provided by the Tx UE and/or the Rx UE. In some aspects, as shown by reference number 606, the Tx UE may then start to perform a sidelink transmission in an earliest candidate starting symbol following a successful LBT procedure. For example, in cases where the successful LBT procedure is completed after the first candidate starting symbol and before the second candidate starting symbol in a current slot, the Tx UE may start the sidelink transmission to the Rx UE in the second candidate starting symbol of the current slot. Alternatively, in cases where the successful LBT procedure is completed after the second candidate starting symbol in the current slot, the Tx UE may start to transmit in the first candidate starting symbol of a next slot.

As further shown in FIG. 6, in example 620, the Tx UE and the Rx UE may communicate with each other over the sidelink channel in accordance with mode 2 scheduling, where sidelink communication is configured and/or scheduled by the Tx UE and/or the Rx UE. Furthermore, in example 620, the sidelink channel that the Tx UE and the Rx UE use to communicate is an unlicensed channel subject to a channel access mechanism (e.g., LBT). Accordingly, as shown by reference number 622, the Tx UE and the Rx UE may communicate to configure the candidate starting symbols within a sidelink slot based on respective Tx/Rx capability information. For example, in some aspects, the Tx UE and the Rx UE may exchange Tx/Rx capability information that indicates respective Tx and Rx capabilities of the Tx UE and the Rx UE (e.g., using PC5-RRC messages or MAC-CEs), which may include one or more parameters relevant to the capability of the Tx UE and/or the Rx UE to transmit and/or receive a sidelink communication in a second candidate starting symbol within a sidelink slot. Accordingly, as shown by reference number 624, the Tx UE may then start to perform a sidelink transmission in an earliest candidate starting symbol following a successful LBT procedure. For example, if the successful LBT procedure is completed after the first candidate starting symbol and before the second candidate starting symbol in a current slot, the Tx UE may start the sidelink transmission in the second candidate starting symbol of the current slot. Alternatively, in cases where the successful LBT procedure is completed after the second candidate starting symbol in the current slot, the Tx UE may start to transmit in the first candidate starting symbol of a next slot.

In some aspects, as described herein, the sidelink slot structure that is configured for the sidelink communication between the Tx UE and the Rx UE may be based on the Tx/Rx capabilities of the Tx UE and/or the Rx UE. For example, reference number 630 depicts a general structure for a sidelink slot with two candidate starting symbols for a PSCCH transmission and/or a PSSCH transmission. For example, as shown, the location of the first candidate starting symbol may be configured to be any of the first seven symbols within the slot (e.g., corresponding to index 0, 1, 2, 3, 4, 5, or 6) per bandwidth part. Alternatively, if the first candidate starting symbol is not specifically configured or otherwise defined (e.g., in a wireless communication standard), a default location for the first candidate starting symbol is the first symbol within the slot (e.g., corresponding to index 0). Furthermore, the second candidate starting symbol may be configured to be any of the fourth through eighth symbols within the slot (e.g., corresponding to index 3, 4, 5, 6, or 7) per bandwidth part, and is generally configured to occur later within the slot relative to the first candidate starting symbol. As described herein, the location of the candidate starting symbol may be configured (e.g., by the network node in an in-coverage and/or partial coverage scenario, or by the Tx UE or the Rx UE in a partial coverage or out-of-coverage scenario) based on the Tx/Rx capabilities of the Tx UE and/or the Rx UE.

For example, in some aspects, the Tx capability information may include any suitable information or parameter(s) related to which of the possible locations for the second candidate starting symbol are supported by a UE when performing a sidelink transmission over an unlicensed channel. For example, in some aspects, the Tx capability information may indicate a time duration that the Tx UE and/or the Rx UE require to generate a waveform corresponding to PSCCH and/or PSSCH transmission following a successful LBT procedure. In such cases, the second candidate starting symbol may be configured to be later within the slot (e.g., in symbol 6 or 7) for a Tx UE that requires a relatively long time duration to generate the waveform, or earlier within the slot (e.g., in symbol 3 or 4) for a Tx UE that requires a relatively short time duration to generate the waveform. Additionally, or alternatively, the Tx capability information may directly or explicitly indicate one or more locations that the associated UE supports for the second candidate starting symbol (e.g., using a bitmap or other suitable indicator). In such cases, the second candidate starting symbol may be configured to be any suitable symbol included among the one or more locations that the associated UE supports for the second candidate starting symbol. Additionally, or alternatively, the Tx capability information may indicate a minimum number of symbols that the associated UE requires for a gap between the first candidate starting symbol and the second candidate starting symbol (e.g., to account for the time needed to perform an LBT procedure and generate the waveform if the LBT procedure is successful). In such cases, the first candidate starting symbol may be configured based on the bandwidth part or the default rule, and the second candidate starting symbol may be any of the fourth through eighth symbols that are later than the first candidate starting symbol by at least the minimum number of symbols indicated in the Tx capability information.

Furthermore, in some aspects, the Rx capability information that is used to determine the location of the second candidate starting symbol may indicate a maximum number of symbols for which the associated UE supports blind detection. For example, an Rx UE may generally perform blind detection in one or more candidate starting symbols to detect a potential transmission from a Tx UE, but the number of symbols in which the Rx UE can perform blind detection may be limited (e.g., to conserve power). Accordingly, the Tx UE and the Rx UE may indicate (e.g., to the network node or each other) the maximum number of symbols for which the associated UE supports blind detection such that the second candidate starting symbol falls within the symbols in which an Rx UE is performing blind detection. Additionally, or alternatively, the Rx capability information may indicate one or more locations where the associated UE supports receiving a PSCCH and/or a PSSCH transmission. For example, because there are five potential locations for the second candidate starting symbol (e.g., any of symbols 3, 4, 5, 6, or 7), the Rx capability information may include five bits to indicate the supported locations for the second candidate starting symbol. For example, each of the five bits may correspond to one of the five potential locations for the second candidate starting symbol, and a value of each bit may indicate whether the associated UE supports receiving a sidelink transmission that starts in the corresponding location. Alternatively, in some aspects, the Rx capability information may include four bits to indicate whether the associated UE supports receiving a sidelink transmission in symbols 3, 4, 5, or 6. In this case, symbol 7 may be defined or configured as a default second starting symbol that is supported by all UEs, whereby only four bits may be needed (rather than five) to indicate the supported symbols for receiving a sidelink transmission that starts in the second candidate starting symbol.

Additionally, or alternatively, the Rx capability information may indicate an index to a table that defines associations between the Rx capability of the supported location(s) for the second candidate starting symbol. For example, as shown in Table 1 below, each row in the table may be associated with an index, which is associated with a number of symbols that the associated UE supports for the second candidate starting symbol and a set of symbols that the associated UE supports for the second candidate starting symbol. For example, if the Rx capability of the associated UE is that the UE supports one possible location for the second candidate starting symbol, the Rx capability information may indicate an index to a row in the table that specifies a symbol that the associated UE supports for the second candidate starting symbol. For example, as shown in the following table, an index of 1 may indicate that the associated UE supports one second candidate starting symbol, corresponding to symbol s_{1,1} (where symbol s_{1,1} is any of symbols 3, 4, 5, 6, or 7), an index of 2 may indicate that the associated UE supports one second candidate starting symbol, corresponding to symbol s_{1,2} (where symbol s_{1,2} is any of symbols 3, 4, 5, 6, or 7 and different from symbol s_{1,1}), and so on through an index of M that may indicate that the associated UE supports all five possible locations for the second candidate starting symbol (note that M have a value that is less than 32, whereby the table may not account for every possible permutation of the five possible locations for the second candidate starting symbol).

TABLE 1

| Index | Rx capability | Second starting symbol candidates |
|---|---|---|
| 1 | 1 | {s_{1, 1}} |
| 2 | 1 | {s_{1, 2}} |
| . . . | . . . | |
| M | 5 | {3, 4, 5, 6, 7} |

In some aspects, a mapping rule may be defined between the second candidate starting symbol and the Tx/Rx capability information of the Tx UE and the Rx UE communicating over the unlicensed sidelink channel. For example, in cases where the Rx capability information indicates the maximum number of symbols in which the associated UE supports blind detection, there is a possibility that an Rx UE may be communicating on a sidelink with more than one Tx UE. In such cases, different Tx UEs may potentially select or be configured with different locations for the second candidate starting symbol, which may result in the Rx UE having to perform blind detection during a number of symbols that exceeds the maximum number of symbols in which the Rx UE supports blind detection (e.g., even if each Tx UE individually ensures that the blind detection performed by the Rx UE does not exceed the maximum number of symbols in which the Rx UE supports blind detection). Accordingly, in cases where an Rx UE supports monitoring N starting positions for a PSCCH and/or a PSSCH based on the Rx capability information indicating the maximum number of symbols in which the Rx UE supports blind detection, the second candidate starting symbol may correspond to any of the first N−1 or the last N−1 symbols among the possible locations for the second candidate starting symbol (e.g., out of symbols 3, 4, 5, 6, and 7). In such cases, the Tx UE may then select the second candidate starting symbol from the first N−1 symbols or the last N−1 symbols in the set of possible locations for the second candidate starting symbol. Alternatively, in cases where the Rx capability information includes four or five bits or an index to a table to indicate N locations that the Rx UE supports for the second candidate starting symbol, the Tx UE may select the second candidate starting symbol from the N locations that the Rx UE supports for the second candidate starting symbol. For example, in FIG. 6, reference number 632 illustrates an example in which the Tx capability of a Tx UE supports using any of the fifth through eighth symbols in a slot as the second candidate starting symbol, and the Rx capability of an Rx UE supports using any of the sixth through eighth symbols in a slot as the second candidate starting symbol. In such cases, the Tx UE may select the second candidate starting symbol from the symbols included in the set of possible locations that the Rx UE supports for the second candidate starting symbol.

As indicated above, FIG. 6 is provided as an example. Other examples may differ from what is described with regard to FIG. 6.

FIG. 7 is a diagram illustrating an example process 700 performed, for example, by a UE, in accordance with the present disclosure. Example process 700 is an example where the UE (e.g., UE 120) performs operations associated with a second starting symbol location in sidelink unlicensed.

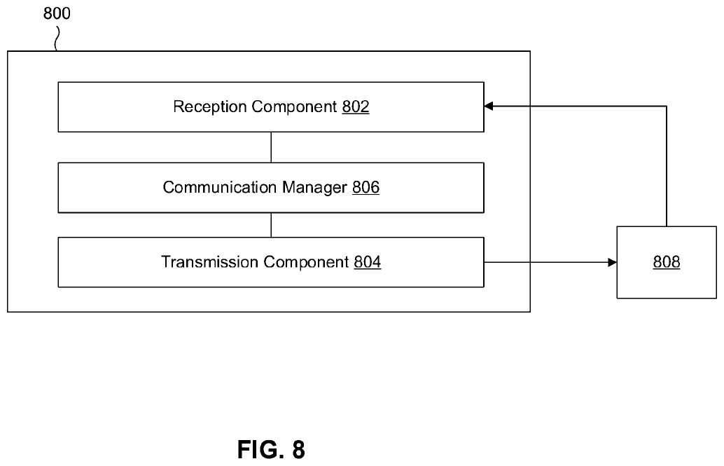

As shown in FIG. 7, in some aspects, process 700 may include transmitting information that indicates a Tx capability and an Rx capability respectively related to transmitting and receiving a sidelink communication over an unlicensed channel (block 710). For example, the UE (e.g., using transmission component 804 and/or communication manager 806, depicted in FIG. 8) may transmit information that indicates a Tx capability and an Rx capability respectively related to transmitting and receiving a sidelink communication over an unlicensed channel, as described above.

As further shown in FIG. 7, in some aspects, process 700 may include receiving a configuration that indicates, within a sidelink slot, a first candidate starting symbol and a second candidate starting symbol for a sidelink transmission, wherein the second candidate starting symbol is based on one or more of the Tx capability or the Rx capability (block 720). For example, the UE (e.g., using reception component 802 and/or communication manager 806, depicted in FIG. 8) may receive a configuration that indicates, within a sidelink slot, a first candidate starting symbol and a second candidate starting symbol for a sidelink transmission, wherein the second candidate starting symbol is based on one or more of the Tx capability or the Rx capability, as described above.

Process 700 may include additional aspects, such as any single aspect or any combination of aspects described below and/or in connection with one or more other processes described elsewhere herein.

In a first aspect, the Tx capability indicates a required time duration to generate a waveform associated with the sidelink communication.

In a second aspect, alone or in combination with the first aspect, the Tx capability indicates, within the sidelink slot, one or more supported locations for the second candidate starting symbol.

In a third aspect, alone or in combination with one or more of the first and second aspects, the Tx capability indicates a minimum number of symbols between the first candidate starting symbol and the second candidate starting symbol.

In a fourth aspect, alone or in combination with one or more of the first through third aspects, the Rx capability indicates a maximum number of symbols in which blind detection of the sidelink communication is supported.

In a fifth aspect, alone or in combination with one or more of the first through fourth aspects, the second candidate starting symbol has an index that is selected from a set of candidate starting symbols having a number of members that does not exceed the maximum number of symbols in which blind detection of the sidelink communication is supported.

In a sixth aspect, alone or in combination with one or more of the first through fifth aspects, the Rx capability indicates one or more supported locations, within the sidelink slot, for the sidelink communication.

In a seventh aspect, alone or in combination with one or more of the first through sixth aspects, the Rx capability indicates, for each of multiple candidate locations for the second candidate starting symbol, whether the respective candidate locations are among the supported locations for the sidelink communication.

In an eighth aspect, alone or in combination with one or more of the first through seventh aspects, the Rx capability indicates, for each of multiple candidate locations for the second candidate starting symbol other than a default candidate location for the second starting symbol, whether the respective candidate locations are among the supported locations for the sidelink communication.

In a ninth aspect, alone or in combination with one or more of the first through eighth aspects, the Rx capability indicates an index to a table that defines an association between the index and the one or more supported locations, within the sidelink slot, for the sidelink communication.

In a tenth aspect, alone or in combination with one or more of the first through ninth aspects, process 700 includes transmitting, to a receiving UE, a sidelink communication based on a successful listen-before-talk procedure, wherein the sidelink communication is transmitted, within a sidelink slot, starting from a second starting symbol that is selected from the one or more supported locations indicated by the Rx capability of the receiving UE.

In an eleventh aspect, alone or in combination with one or more of the first through tenth aspects, the information that indicates the Tx capability and the Rx capability is transmitted in an RRC message.

In a twelfth aspect, alone or in combination with one or more of the first through eleventh aspects, the information that indicates the Tx capability and the Rx capability is transmitted in a MAC-CE.

In a thirteenth aspect, alone or in combination with one or more of the first through twelfth aspects, the information that indicates the Tx capability and the Rx capability is transmitted to a network node or a UE, and the configuration that indicates the first candidate starting symbol and the second candidate starting symbol is received from the network node or the UE.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 140 described in connection with FIG. 1. As shown, the apparatus 800 may communicate with another apparatus 808, such as a UE or a network node (such as a CU, a DU, an RU, or a base station), using the reception component 802 and the transmission component 804.

In some aspects, the apparatus 800 may be configured to perform one or more operations described herein in connection with FIG. 6. Additionally, or alternatively, the apparatus 800 may be configured to perform one or more processes described herein, such as process 700 of FIG. 7. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 808. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The transmission component 804 may transmit information that indicates a Tx capability and an Rx capability respectively related to transmitting and receiving a sidelink communication over an unlicensed channel. The reception component 802 may receive a configuration that indicates, within a sidelink slot, a first candidate starting symbol and a second candidate starting symbol for a sidelink transmission, wherein the second candidate starting symbol is based on one or more of the Tx capability or the Rx capability.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a UE, comprising: transmitting information that indicates a Tx capability and an Rx capability respectively related to transmitting and receiving a sidelink communication over an unlicensed channel; and receiving a configuration that indicates, within a sidelink slot, a first candidate starting symbol and a second candidate starting symbol for a sidelink transmission, wherein the second candidate starting symbol is based on one or more of the Tx capability or the Rx capability.

Aspect 2: The method of Aspect 1, wherein the Tx capability indicates a required time duration to generate a waveform associated with the sidelink communication.

Aspect 3: The method of any of Aspects 1-2, wherein the Tx capability indicates, within the sidelink slot, one or more supported locations for the second candidate starting symbol.

Aspect 4: The method of any of Aspects 1-3, wherein the Tx capability indicates a minimum number of symbols between the first candidate starting symbol and the second candidate starting symbol.

Aspect 5: The method of any of Aspects 1-4, wherein the Rx capability indicates a maximum number of symbols in which blind detection of the sidelink communication is supported.

Aspect 6: The method of Aspect 5, wherein the second candidate starting symbol has an index that is selected from a set of candidate starting symbols having a number of members that does not exceed the maximum number of symbols in which blind detection of the sidelink communication is supported.

Aspect 7: The method of any of Aspects 1-6, wherein the Rx capability indicates one or more supported locations, within the sidelink slot, for the sidelink communication.

Aspect 8: The method of Aspect 7, wherein the Rx capability indicates, for each of multiple candidate locations for the second candidate starting symbol, whether the respective candidate locations are among the supported locations for the sidelink communication.

Aspect 9: The method of Aspect 7, wherein the Rx capability indicates, for each of multiple candidate locations for the second candidate starting symbol other than a default candidate location for the second starting symbol, whether the respective candidate locations are among the supported locations for the sidelink communication.

Aspect 10: The method of Aspect 7, wherein the Rx capability indicates an index to a table that defines an association between the index and the one or more supported locations, within the sidelink slot, for the sidelink communication.

Aspect 11: The method of Aspect 7, further comprising: transmitting, to a receiving UE, a sidelink communication based on a successful listen-before-talk procedure, wherein the sidelink communication is transmitted, within a sidelink slot, starting from a second starting symbol that is selected from the one or more supported locations indicated by the Rx capability of the receiving UE.

Aspect 12: The method of any of Aspects 1-11, wherein the information that indicates the Tx capability and the Rx capability is transmitted in an RRC message.

Aspect 13: The method of any of Aspects 1-12, wherein the information that indicates the Tx capability and the Rx capability is transmitted in a MAC-CE.

Aspect 14: The method of any of Aspects 1-13, wherein the information that indicates the Tx capability and the Rx capability is transmitted to a network node or a UE, and wherein the configuration that indicates the first candidate starting symbol and the second candidate starting symbol is received from the network node or the UE.

Aspect 15: An apparatus for wireless communication at a device, comprising a processor; memory coupled with the processor; and instructions stored in the memory and executable by the processor to cause the apparatus to perform the method of one or more of Aspects 1-14.

Aspect 16: A device for wireless communication, comprising a memory and one or more processors coupled to the memory, the one or more processors configured to perform the method of one or more of Aspects 1-14.

Aspect 17: An apparatus for wireless communication, comprising at least one means for performing the method of one or more of Aspects 1-14.

Aspect 18: A non-transitory computer-readable medium storing code for wireless communication, the code comprising instructions executable by a processor to perform the method of one or more of Aspects 1-14.

Aspect 19: A non-transitory computer-readable medium storing a set of instructions for wireless communication, the set of instructions comprising one or more instructions that, when executed by one or more processors of a device, cause the device to perform the method of one or more of Aspects 1-14.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
one or more memories; and
one or more processors, coupled to the one or more memories, configured to:
transmit information that indicates a transmission (Tx) capability and a reception (Rx) capability respectively related to transmitting and receiving a sidelink communication over an unlicensed channel; and
receive a configuration that indicates, within a sidelink slot, a first candidate starting symbol and a second candidate starting symbol for a sidelink transmission, wherein the second candidate starting symbol is based on one or more of the Tx capability or the Rx capability.

2. The UE of claim 1, wherein the Tx capability indicates a required time duration to generate a waveform associated with the sidelink communication.

3. The UE of claim 1, wherein the Tx capability indicates, within the sidelink slot, one or more supported locations for the second candidate starting symbol.

4. The UE of claim 1, wherein the Tx capability indicates a minimum number of symbols between the first candidate starting symbol and the second candidate starting symbol.

5. The UE of claim 1, wherein the Rx capability indicates a maximum number of symbols in which blind detection of the sidelink communication is supported.

6. The UE of claim 5, wherein the second candidate starting symbol has an index that is selected from a set of candidate starting symbols having a number of members that does not exceed the maximum number of symbols in which blind detection of the sidelink communication is supported.

7. The UE of claim 1, wherein the Rx capability indicates one or more supported locations, within the sidelink slot, for the sidelink communication.

8. The UE of claim 7, wherein the Rx capability indicates, for each of multiple candidate locations for the second candidate starting symbol, whether the respective candidate locations are among the supported locations for the sidelink communication.

9. The UE of claim 7, wherein the Rx capability indicates, for each of multiple candidate locations for the second candidate starting symbol other than a default candidate location for the second starting symbol, whether the respective candidate locations are among the supported locations for the sidelink communication.

10. The UE of claim 7, wherein the Rx capability indicates an index to a table that defines an association between the index and the one or more supported locations, within the sidelink slot, for the sidelink communication.

11. The UE of claim 7, wherein the one or more processors are further configured to:
transmit, to a receiving UE, a sidelink communication based on a successful listen-before-talk procedure, wherein the sidelink communication is transmitted, within a sidelink slot, starting from a second starting symbol that is selected from the one or more supported locations indicated by the Rx capability of the receiving UE.

12. The UE of claim 1, wherein the information that indicates the Tx capability and the Rx capability is transmitted in a radio resource control message.

13. The UE of claim 1, wherein the information that indicates the Tx capability and the Rx capability is transmitted in a medium access control (MAC) control element (MAC-CE).

14. The UE of claim 1, wherein the information that indicates the Tx capability and the Rx capability is transmitted to a network node or a UE, and wherein the configuration that indicates the first candidate starting symbol and the second candidate starting symbol is received from the network node or the UE.

15. A method of wireless communication performed by a user equipment (UE), comprising:
transmitting information that indicates a transmission (Tx) capability and a reception (Rx) capability respectively related to transmitting and receiving a sidelink communication over an unlicensed channel; and
receiving a configuration that indicates, within a sidelink slot, a first candidate starting symbol and a second candidate starting symbol for a sidelink transmission, wherein the second candidate starting symbol is based on one or more of the Tx capability or the Rx capability.

16. The method of claim 15, wherein the Tx capability indicates a required time duration to generate a waveform associated with the sidelink communication.

17. The method of claim 15, wherein the Tx capability indicates, within the sidelink slot, one or more supported locations for the second candidate starting symbol.

18. The method of claim 15, wherein the Tx capability indicates a minimum number of symbols between the first candidate starting symbol and the second candidate starting symbol.

19. The method of claim 15, wherein the Rx capability indicates a maximum number of symbols in which blind detection of the sidelink communication is supported.

20-29. (canceled)

30. An apparatus for wireless communication, comprising:
means for transmitting information that indicates a transmission (Tx) capability and a reception (Rx) capability respectively related to transmitting and receiving a sidelink communication over an unlicensed channel; and
means for receiving a configuration that indicates, within a sidelink slot, a first candidate starting symbol and a second candidate starting symbol for a sidelink transmission, wherein the second candidate starting symbol is based on one or more of the Tx capability or the Rx capability.
